(19) United States
(12) Patent Application Publication
(10) Pub. No.: US 2011/0162940 A1
(43) Pub. Date: Jul. 7, 2011

(54) SPONGY MASS FOR TREATING END WALLS OF THERMOPLASTIC CONTAINERS AND DEVICE EQUIPPED THEREWITH ESPECIALLY FOR COOLING THE HOT END WALLS OF CONTAINERS LEAVING A MOLDING UNIT

(75) Inventors: Mikaël Derrien, Octeville-sur-Mer (FR); Guy Feuilloley, Octeville-sur-Mer (FR)

(73) Assignee: SIDEL PARTICIPATIONS, Octeville-Sur-Mer (FR)

(21) Appl. No.: 13/056,618

(22) PCT Filed: Jul. 30, 2009
(86) PCT No.: PCT/FR2009/051531

§ 371 Date: Jan. 28, 2011

(30) Foreign Application Priority Data
Jul. 31, 2008 (FR) 08 55283

(51) Int. Cl. B32B 3/26; B65G 29/00

(52) U.S. Cl. 198/339.1; 428/160

(57) ABSTRACT

Spongy mass (4) suitable for being brought into contact with the end wall of a container for a predetermined time, for treating said end wall of the container. Said mass consists of a soft crosslinked foam having semi-open cells and high resilience, has a main face (14) for contact with the end wall of the container and includes blind grooves (15) which open onto said main face (14), but do not emerge on the opposite side, and that are distributed in two sets of mutually transverse grooves (15a, 15b) that define blocks (16). Application: cooling of the end walls of thermoplastic containers leaving a moulding unit; wiping of the end walls of thermoplastic containers.

### FIELD OF THE INVENTION

The present invention generally relates to the field of manufacturing thermoplastic containers, and more particularly relates to the treatment of end walls of thermoplastic containers, particularly but not exclusively for the cooling of hot end walls of containers made of a thermoplastic material, such as PET, leaving a blow molding or stretch-blow molding unit based on heated preforms in molds.

### BACKGROUND OF THE INVENTION

The end wall is the part of thermoplastic containers that is the most difficult to treat and that requires the most attention during the manufacturing process.

The end wall is the thickest part of the containers, at least in parts (typically, the thickness of the end wall can be between one and twenty times the thickness of the wall of the container body at some points at least). As a result, the end wall accumulates a large amount of heat during the heating step performed prior to the molding step. This heat is still present when the finished container is removed from the mold.

The hot end wall is mechanically very fragile, because the still very hot thermoplastic material can become deformed from its own weight and/or from the residual stresses associated with the blowing process. Having a perfectly shaped container end wall ensures container stability when it is placed on a flat surface, and any deformation of the end wall compromises this stability and results in a commercially unusable container.

It is therefore of great importance that the material that forms the end wall be cooled as quickly as possible when the finished container leaves the mold, so that it is stabilized in the required shape imparted by the mold. In any event it is desirable for the shape of the end wall to be stable, and therefore for the temperature to be lowered, when the container reaches the next processing station.

In the past, the end walls of containers leaving a molding unit could be cooled naturally by the ambient atmosphere as they traveled the path leading to the next station (for example a filling machine) when that path was sufficiently long (e.g. a few dozen seconds).

Some systems have also sprayed a gaseous fluid (usually air) or a liquid (usually water) in the form of a possibly cooled mist, onto the end walls of the containers filing out of the molding system, in order to accelerate the cooling of the end walls. However, this type of arrangement complicates the structural design of already highly encumbered systems and also increases manufacturing and maintenance costs. Furthermore, coolant sprays can cause pollution (bacteria, etc.), both from the blowing system and the final containers, as well as disturbances in adjacent parts of the system. For this reason, avoiding such arrangements is preferred.

Finally and most importantly, the operators of thermoplastic container production facilities require ever-increasing operating speeds, and rates on the order of 80,000 containers per hour are currently anticipated. In addition, the need for increasingly compact systems in order to fit into smaller spaces is leading to closer proximity of the various processing stations, for example between the blow-molding system and the filling system that follows it. This results in a considerable shortening of the container transit time. For example, the time for transferring containers between the blow-molding system and the filling system may be reduced to only a few seconds. It is no longer possible under such conditions for the end walls of the containers leaving the molding unit to be cooled under the same conditions used in the past.

Independently of what has just been described concerning the cooling of hot end walls of thermoplastic containers leaving the molding unit, and in the general context of thermoplastic container manufacturing, some production processes may require the application of a product in fluid form, particularly a liquid, to the end wall of thermoplastic containers, not to lower the temperature as described above, but rather to raise the temperature or to modify the surface finish of the container end wall. In at least some cases, the surface finish of the container end wall may be modified by applying a suitable fluid, particularly a liquid, to the outer face of said end wall (Examples: depositing a layer to protect against corrosive chemicals, coloring the outer face of the end walls for decorative purposes . . . ).

Conversely, it may also be desirable to remove at least a large part of a substance from the end walls of containers after treatment, for example removing a liquid phase from the end walls after applying a liquid coolant to said end walls (wiping the end walls, drying the end walls).

### SUMMARY OF THE INVENTION

The invention proposes an improved means of treating the end walls of containers, particularly but not exclusively in order to cool rapidly the end walls of containers leaving the molding unit, or to wipe or dry the end walls of containers, under cost and space conditions that are acceptable for facilities operating at very high production rates and under technical conditions that result in no change or disturbance to upstream or downstream processes.

For that purpose, a first aspect of the invention proposes a spongy mass for treating the end walls of containers produced in facilities that operate at very high production rates, said spongy mass suitable for being held in contact with the end wall of a container for a predetermined period in order to treat said end wall of the container, with said mass:

having a main face for contact with the end wall of the container, and

comprising blind grooves which open onto said main face but do not emerge on the opposite side, and which are distributed into two sets of mutually transverse grooves that delimit blocks.

The spongy mass is noteworthy in that it consists of flexible reticulated foam with semi-open cells and high resilience, and in that it consists of polyurethane foam with a mass density between about 10 and 600 kg/m³.

In the context of the invention as set forth, the term “treatment” should be understood to mean any application of any product to the end walls of containers or, conversely, at least partial removal of a product from the end walls of containers, by simple contact with a spongy mass having a predetermined required quality, meaning it is saturated with the product to be applied or conversely it is rid of the traces of the product to be removed.

Preferably, the polyurethane foam constituting the spongy mass is a polyether polyurethane foam or a polyester polyurethane foam. The mass density is between about 10 and 600 kg/m³, so that the spongy mass can withstand high production rates and still be flexible enough to allow the compression of individual blocks, such that the spongy mass conforms to the shape of the container end walls in the best possible manner.

In an advantageous embodiment, the most appropriate mass density is approximately 38 kg/m³.

Advantageously, the depth of said grooves is between about 7 and 15 mm, preferably about 10 mm, and in practice they may be about 1 mm in width.

In a practical embodiment that is simple to manufacture, said grooves are mutually substantially parallel within each set, and the grooves of one set are substantially perpendicular to those of the other set.

In a practical embodiment, said blocks have a substantially square shape measuring about 15 to 25 mm on each side, and preferably about 19 mm, with said grooves spaced about 20 mm apart.

In yet another practical embodiment, the spongy mass has a substantially quadrangular general shape in a top view, and in particular has a substantially square general shape, and said grooves of the two sets are substantially parallel to its respective sides.

To simplify the assembly and replacement of the spongy masses during maintenance, in two mutually opposite areas on the periphery of its lower portion underlying said grooves, each spongy mass may comprise two substantially parallel lateral scores cut into the lateral wall substantially perpendicularly to said grooves. Thus a forked support may be provided, with arms onto which the spongy mass is slid.

In current practice, the main face of the spongy mass may be substantially flat, and experience has shown that such a structure is entirely satisfactory for treating end walls of any shape, including complex shapes (so called “petaloid” end walls, for example). However, if need be, at least the center of the main face of the spongy mass may be rounded in relation to the shape of the end wall of the containers (and in particular may be concave or convex, depending on the shape of said end wall).

A spongy mass according to the invention affords excellent deformability, both in amplitude and surface area. Thus, in the preferred embodiment described above with grooves about 10 mm deep, the blocks of the spongy mass are capable of sustaining about 20 mm of compression. Furthermore, the advantage of dividing the spongy mass into independent blocks is that each block can sustain individual compression according to the specific shape of the portion of end wall surface of the container with which it is in contact, independently of the adjacent blocks; thus the spongy mass can be placed in continuous contact with the entire surface of the end wall of the container, even if the shape of the end wall is complex, such as a petaloid end wall.

In addition, the preferred dimensions indicated in the exemplary embodiments allow the blocks to be compressed individually, without the possibility of folding and interfering with one another. This ensures that the spongy mass will retain its shape and therefore its characteristics and functional capabilities; furthermore, as each block is independently compressed against the end wall in relation to the local shape of the end wall, the stress exerted on the end wall of the containers is significantly reduced, thus avoiding any risk of accidental deformation of the end wall. This advantage is essential when operating at very high speeds, especially in the case of a system as described below, which needs to be capable of operating at a very high speed, since, in a preferred application, a heat transfer fluid, particularly a liquid, is applied to the end walls of successive containers for the purpose of cooling their end walls as they leave the hot blow molding unit. With a processing speed for each mold on the order of 1800 containers per hour, each spongy mass (sustaining about 20 mm of deflection in contact with the end wall) remains in contact with the end wall of a container, whose temperature on leaving the mold may be about 70° C. to 85° C., for about 0.9 seconds.

A second aspect of the invention proposes a system for treating the end wall of at least one thermoplastic container, comprising:
at least one spongy mass having a predetermined quality (meaning, as indicated above, it is saturated with a product to be applied to the end wall of a container, or conversely it is rid of traces of a product to be removed from the end wall of a container, by being wrung out for example), and
support means suitable for holding said spongy mass in contact with the end wall of at least one container for a predetermined period,
   wherein said spongy mass is constituted as described above, said system being arranged according to the invention.

The arrangements according to the invention may be implemented in any type of system. However, these arrangements may be particularly beneficial, in terms of treatment capacity, when applied to a rotary carousel-type system arranged as explained above and comprising:
conveyor means for conveying the container, which move in a substantially circular manner and advance the containers along a substantially arc-shaped path between a point of entry and a point of exit,
a plurality of spongy masses supported one after the other,
support means for the respective spongy masses, arranged in a substantially circular manner and made to rotate on a circular path substantially parallel and coaxial to the path traveled by the end walls of the containers,
driving means suitable for mutually moving said conveyor means for the containers and/or said support means for the spongy masses, such that the container end walls are in contact with the respective spongy masses for at least a portion of said substantially arc-shaped path traveled by the containers, and
means of regenerating the predetermined quality of the spongy masses, arranged in the portion of said circular path located between the point of exit and the point of entry of the containers on said path.

In a preferred embodiment, each support means comprises a substantially flat perforated base integral with the transfer means and a platen for receiving at least one spongy mass detachably affixed to said base such that the spongy mass is atop said base.

As explained above, if the spongy mass comprises two substantially parallel lateral scores cut into the lateral wall substantially perpendicularly to said grooves in two mutually opposite areas on the periphery of its lower portion underlying said grooves, then, in a simple arrangement, said platen may be in the form of a fork with two arms that are respectively inserted into the two lateral scores in the spongy mass. It is then beneficial for each support means to be arranged to support two spongy masses side by side.

A system arranged as explained above may also be used to deposit a product on the end walls of the containers, particularly a liquid such as a heat transfer liquid (such as water), in order to modify the temperature of said end wall (cooling it, for example), or, on the contrary, to remove at least part of a product from said end wall, for example to remove (at least partially drying) a liquid such as water which may result from a prior step, for example a step of cooling said end walls as they leave the blow molds.

By means of the arrangements just been described, it is possible to construct a system capable of meeting user requirements in terms of operating speed, quality of the results obtained, and simplification of maintenance, particularly for the replacement of spongy masses for maintenance purposes.

Finally, the invention relates to the use of a spongy mass as defined above, for treating the end walls of containers produced in very high production rate facilities. The treatment may consist of the application of product or wiping off (removal of product).

### BRIEF DESCRIPTION OF THE DRAWINGS

The invention will be better understood by reading the following detailed description of some embodiments provided as non-limiting examples. The description refers to the attached drawings, in which:

FIG. 1A is a highly schematic view illustrating the general aspects of one possible application of the invention using a spongy mass according to the invention,

FIG. 1B is a highly schematic view, similar to the one in FIG. 1A, illustrating the general aspects of a possible preferred example of the aspects shown in FIG. 1A,

FIG. 2 is a perspective top view of a spongy mass arranged according to the invention,

FIG. 3 is a top view of a rotary carousel-type system incorporating a plurality of spongy masses according to the invention, in a practical implementation of the aspects of FIG. 1, and

FIGS. 4A and 4B are two perspective top views of a support arrangement for spongy masses according to the invention, suitable for use in the system in FIG. 3, FIG. 4B being an exploded view of the assembled arrangement in FIG. 4A.

### DETAILED DESCRIPTION OF THE DRAWINGS

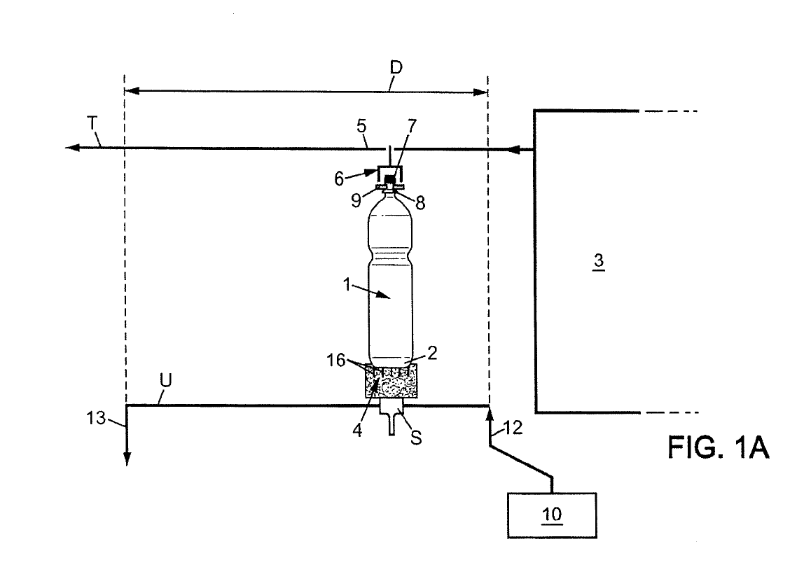

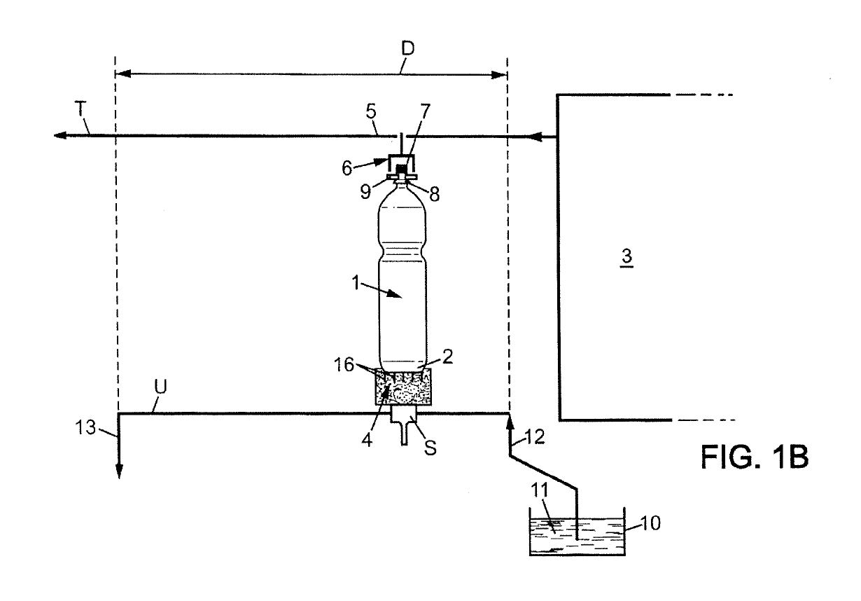

FIG. 1A very schematically illustrates a possible implementation of a process for applying a fluid to the end wall 2 of at least one container 1, particularly a bottle, made of thermoplastic material such as PET. In this particular but not exclusive application of the invention, a heat transfer fluid of an appropriate temperature and possibly with an added additive is applied to the end wall 2 of the container, in order to change the temperature of said end wall 2; more specifically, this may involve applying a cooling fluid to the end wall 2 of the container as it leaves the blow molding unit in order to cool rapidly the material of said end wall so as to stabilize its shape.

In this context, the end wall 2 of said at least one container 1 and a spongy mass 4 saturated with said fluid are brought into mutual contact and that contact is maintained by means of an appropriate support S for a predetermined period.

In an industrial implementation of the method of the invention, which is not exclusive, the container 1 is conveyed along a predetermined path T (indicated by the arrow T), while supported by conveyor means, denoted as 5 in FIG. 1A. It is assumed in the representation in FIG. 1A that the container 1 is supported by a clamping unit 6 comprising clamps 9 around the neck 7 of the container 1, above a flange 8 and between said flange and a thread on said neck 7 for securing a cap, and that said clamping unit 6 is itself supported by the conveyor means 5.

To simplify the representation, although this is not technically related to the invention, the method of the invention is illustrated in FIG. 1A as being implemented in a substantially rectilinear portion of the path T.

For its part, the spongy mass 4 is advanced at substantially the same speed as the container 1 along a path U (indicated in the diagram by the arrow U) of limited length D, substantially parallel to the path T of the container 1, simultaneously with its being maintained in contact with the end wall 2 of the container 1 for said predetermined period.

It should be pointed out that to maintain the spongy mass 4 in contact with the end wall 2 of the container 1, force must be exerted against the end wall 2 of the container, substantially along the axis of said container, meaning substantially vertical from bottom to top in the configuration shown in FIG. 1, for containers conveyed in a substantially vertical position with the neck upwards. As a result, despite the presence of the flange, it is necessary for the clamping unit 6 to grasp the neck 7 of the container 1 with positive force in order to secure the container vertically.

In the schematic representation shown in FIG. 1A, it is assumed that the spongy mass 4 was at least partially saturated with fresh fluid having the desired characteristics, at a particular location 10, for example within an enclosure (indicated as a box in FIG. 1A). Once saturated with fresh fluid in any appropriate manner, for which examples will be provided below, the spongy mass 4 is raised out of the enclosure 10 (arrow 12), then applied against the end wall 2 of the container 1 when they are aligned.

The spongy mass 4 then accompanies said end wall 2 as the container 1 travels along a given portion D of said path T, which corresponds, in relation to the travel speed of the container 1, to a predetermined contact period that should result in obtaining the desired effect on said end wall. At the end of said given portion of the path T, the spongy mass is moved away from the end wall 2 (arrow 13), while the container 1 conveyed by the conveyor means 5 continues its course. The fluid in the spongy mass 4 may have at least partially disappeared (for example presence or appearance of a liquid phase which has dripped off) and may possibly have lost all or some of its characteristics in contact with the end wall 2, and can then be returned to its starting point near the enclosure 10 where it is again loaded with fresh fluid, awaiting the arrival of another container 1.

Although the general aspects that have just been described can be implemented with a fluid that is a gas, the simplest and most effective implementation of a spongy mass according to the invention seems to consist of a fluid that is a liquid. This is the example illustrated in FIG. 1B (which is analogous to FIG. 1A discussed above), in which the aforesaid location 10 may be in the form of a tank, also denoted 10, which contains a liquid 11. During the cycle, the spongy mass 4 is, for example, immersed in the tank 10, then removed therefrom to be placed in contact with the end wall 2 of a container, then finally returned to the tank 10 to be reloaded with liquid 11.

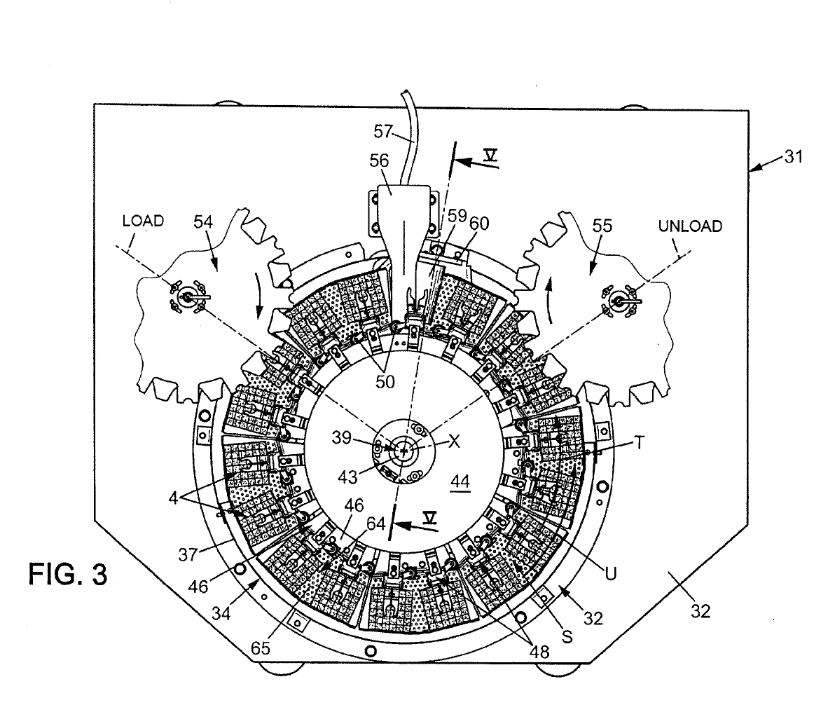

Of course, this is only one exemplary implementation provided to facilitate understanding, and in practice other solutions may be used for loading the spongy mass 4 with fresh liquid (another solution is defined below, with reference to FIG. 3).

Note that, in the examples illustrated in FIGS. 1A and 1B, the conveyor means 5 are represented as conveying the containers 1 along a path T at a substantially constant level, while it is the spongy mass 4 that is raised in order to be placed against the end wall 2 of the successive containers 1. But there may be other solutions, such as moving the spongy mass along at a constant level and giving a vertical motion component to the container to bring its end wall to rest against the spongy mass and then to move it away.

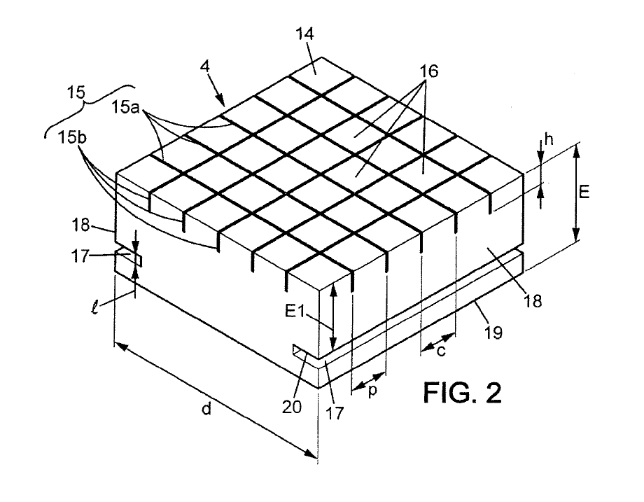

FIG. 2 illustrates a spongy mass 4 arranged according to the invention.

The spongy mass 4 consists of a flexible reticulated foam with semi-open cells and high resilience (cellular foam technology). Preferably it can be a polyurethane foam, and particularly a polyether polyurethane foam or a polyester polyurethane foam, having a density between about 10 and 600 kg/m3, and preferably about 38 kg/m3. Advantageously, at least in the context of the preferred application described above, this foam is white in color. Given the intended conditions of use, this foam may preferably have a flash point between 315° C. and 370° C., a decomposition temperature greater than 180° C., and thermal energy on the order of 28,000 kJ/kg. A foam of the type indicated above is, for example, marketed in France by the company Recticel France SAS.

Because of these aspects, it is possible for a spongy mass produced in this manner to have a long service life, enabling it, in the context of the application more specifically addressed above, to withstand a high number of compression/expansion cycles when wringing it out when the spongy mass needs to be emptied of at least a portion of the liquid phase it contains (typically around 1.5 million cycles corresponding to a production capacity on the order of 1800 containers per hour per mold in a facility that can have up to about 46 molds, over a period of about 35 days).

As is clearly shown in FIG. 2, the spongy mass 4 according to the invention has a main face 14 for contact with the end wall 2 of the container (upper face in the operating configuration illustrated in FIG. 1) and comprises two sets of mutually transverse blind grooves 15 that open onto said main face but do not emerge on the opposite side. The grooves 15 belonging to these two sets are respectively denoted by the numeric references 15a, 15b, and they delimit blocks 16. This block configuration of the portion of the spongy mass 4 intended to be applied against the end wall 2 of the containers 1 gives this portion a capacity for deformation (compression) that is relatively homogeneous across the entire face 14, such that contact with the spongy mass is ensured over the entire surface of the end wall.

In one practical embodiment, the grooves 15 have a depth h between about 7 and 15 mm, and preferably about 10 mm, and the spongy mass has a compression capacity of about 20 mm.

The essential characteristic of the blocks lies is their greater capacity for compression than in their own shape, which, in theory, could be any shape at all. However, the manufacturing of such a spongy mass, and in particular the formation of the grooves, is simplified when the grooves 15a, 15b in each set are substantially parallel to each other, and the grooves 15a, 15b in each of the two sets are substantially perpendicular to those of the other set, as illustrated in FIG. 2.

It is also necessary to size the blocks so they can be compressed individually without affecting the neighboring blocks and so their individual surface area is small enough for all blocks to conform to a complex end wall shape, such as a petaloid end wall, but without their individual surface area being too small, to prevent the blocks from being too flexible and to prevent them from folding and entangling with each other which would ruin the functional capabilities of the spongy mass.

In a practical embodiment shown in FIG. 2, the blocks 16 are substantially square in shape and measure about 15 to 25 mm on each side c, typically about 19 mm on each side, with a block pitch p of about 20 mm (meaning the grooves are about 1 mm wide).

The spongy mass 4 itself may have any shape, which can be suited to its conditions of use. In the context of the preferred application more specifically mentioned above, the spongy mass 4 may have a substantially quadrangular general shape in a top view, and the grooves 15a, 15b of the respective two sets may then be substantially parallel to its respective sides. In the practical embodiment illustrated in the top view in FIG. 2, the spongy mass 4 has a substantially square general shape, approximately 118 mm on each side (d), with a thickness E on the order of 40 to 50 mm.

To support the spongy mass 4 and secure it to its support S, which is in the form of a forked support as will be explained in more detail below, in two mutually opposite areas on the periphery of its lower portion underlying said grooves 15, the spongy mass 4 may comprise two substantially parallel lateral scores 17 cut into the lateral wall substantially perpendicularly to said grooves 15. In the substantially parallelepiped configuration of the spongy mass illustrated in FIG. 2, the two scores 17 are cut in two opposite lateral faces 18 of the spongy mass 4, in proximity to its lower portion. For practical purposes, since the spongy mass 4 has a thickness E on the order of 50 mm, the scores 17 have a width I of about 2 mm and their upper face 20 is located about 10 mm from the lower face 19 of the spongy mass 4. As a result, the effective thickness E1 of the spongy mass 4 (meaning the thickness capable of being compressed, blocks included) is about 40 mm, which is sufficient to allow the abovementioned deflection on the order of 20 mm.

In tests that have been conducted, it was found that the expected results could be achieved, including for end walls 2 having complex shapes such as petaloid end walls, by giving the main face 14 of the spongy mass 4 a substantially flat shape as shown in FIG. 2. However, when necessary, the main face of the spongy mass may be shaped differently, at least centrally; in particular, it may, for example, be convex or concave in relation to the shape of the end wall 2 of the containers.

FIG. 3 shows a top view of a carousel-type system rotating around an axis X, which is arranged to implement the general aspects described above with reference to FIGS. 1A and 1B, it again being understood that the aspects specific to the present invention can be used in a differently designed system (for example where it is the containers that are moved vertically in order to be brought into contact with the spongy masses traveling at a constant level).

The system, designated as a whole by the reference 31, comprises a frame 32 having the general shape of a platform that is substantially horizontal and substantially transverse to the axis X.

Using support means that are not visible in FIG. 3, the frame 32 supports a trough or gutter 34 that is substantially annular and substantially coaxial with the axis X, of which only the outer annular wall 37 is visible on the drawing. The gutter 34 is rotationally fixed.

A shaft 39 coaxial with the axis X can be made to rotate, by its lower end projecting below the frame 32, by transmission means (for example a pulley driven by a belt) connected to a driving means (not shown).

At its upper end 43, the shaft 39 supports a disk-shaped drum 44 supporting clamp assemblies 48 suitable for gripping the necks 7 of containers 1. The opening and closing of the clamps of the clamp assemblies 48 may be controlled by control means comprising a cam (not visible) and cam follower(s) 50, as is well known to persons skilled in art.

Under these conditions, the containers 1 are conveyed one after the other along a predetermined path T which is substantially an arc of a circle of a predetermined radius as indicated by an arrow in FIG. 3.

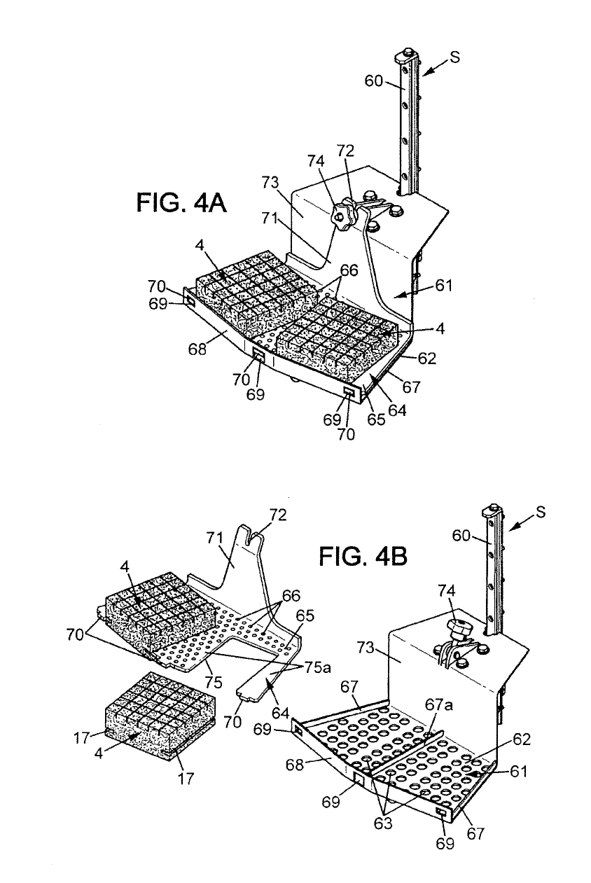

The support means S for the spongy masses 4 comprise a ring 46 that is substantially coaxial with the axis X, which supports a set of spongy masses 4 circularly distributed along its periphery with a constant angular interval between them, by means which will be detailed below with reference to FIGS. 4A, 4B. The ring 46 is supported, in a manner that allows it to rotate freely, by the support means for the gutter 34.

It should be pointed out that each clamp assembly 48 is vertically aligned with a spongy mass 4.

Under these conditions, the spongy masses 4 advance one after the other along a substantially circular path U (symbolized by an arrow in FIG. 3) which has a radius substantially equal to said predetermined radius and which runs substantially parallel and substantially coaxially to said predetermined path T of the containers 1, with said spongy masses 4 being moved synchronously in rotation with said containers 1 and underneath the respective end walls 2 of said containers.

It should also be clarified that, in this embodiment, the support means S for the spongy masses 4 are arranged to raise the spongy masses in order to bring them into contact with the end walls of the containers 1 at the start of treatment and to lower the spongy masses in order to move them away from said end walls at the end of treatment. These raising and lowering movements can be controlled by conventional means comprising a fixed cam and cam followers (not visible in FIG. 3) as is commonly used in this field.

The operation of the system described above is as follows.

As shown in FIG. 3, an infeed transfer wheel 54 brings the containers 1 perpendicular to a loading axis LOAD where they are respectively grasped by the aforesaid clamping means 48. Here, the end walls 2 of the containers 1 are located above the respective spongy masses 4.

The spongy masses 4 are then raised such that the end walls 2 of the containers 1 are forced into contact with the respective spongy masses 4. Each container is then conveyed in this position over a major portion of the circular path, until it is perpendicular to an unloading axis UNLOAD where it is grasped by an outfeed transfer wheel 55. Taking into account the time during which the spongy masses 4 and the end walls 2 of the containers 1 are brought into contact and moved apart, the distance D in which contact is maintained as mentioned above is slightly less (because of loading and unloading times) than the angular distance (in the direction of rotation) between the axes LOAD and UNLOAD.

Drips (condensation on contact with end walls, application of a liquid) from compressed spongy masses 4 fall into the gutter 34. An appropriate arrangement thereof, such as the use of a pump, or more simply a sloped bottom 35, drains out the collected liquid and sends it to a tank (not shown), where it may be retreated and/or reprocessed, for example thermally, for recycling if the system is specifically designed to apply a liquid to the end walls of containers. The draining then occurs in the angular interval between the loading LOAD and unloading UNLOAD axes mentioned above.

The loading of the spongy masses 4 with fresh fluid, particularly with liquid, also occurs in the angular interval between the unloading UNLOAD and loading LOAD axes mentioned above.

If the fluid is a liquid—because it is in that context that the invention seems to find its most common applications (such as cooling the end walls of containers)—fresh liquid may be sprayed above the path followed by the spongy masses 4. Thus, within said angular interval (in the direction of rotation) between the loading LOAD and unloading UNLOAD axes, a supporting arm 56 extends radially above the gutter 34, preferably supported in a fixed manner by the support means for the gutter 34. The arm 56 supports at least one supply line 57 which supplies fresh liquid. Said line 57 may be equipped with a nozzle or boom for spraying liquid onto the spongy masses 4 filing beneath it in order to reload them.

It may also be advantageous to provide, immediately upstream of the arm 56, means for wringing the spongy masses 4, for example in the form of a roller 59 radially positioned so as to squeeze the spongy masses, and supported, in a manner that allows it to rotate freely, by a flange 60 mounted on the arm 56 or on the outer wall 37 of the gutter 34 as shown in FIG. 3.

Similarly, if the system is intended to at least partially dry (meaning to suck up a liquid phase) the end walls of the containers using wrung-out spongy masses, wringing means may be arranged, as just explained, to process the spongy masses that have just been saturated with liquid from contact with the end walls of the containers.

If the spongy masses have been applied against the end walls of the containers in order to rid said end walls of a product (for example, traces of dried or powdered product), the spongy masses may be put through, at the aforesaid location, a liquid bath or under a shower and then wrung out as indicated.

To expand the domain of uses for the system that has just been described, it is desirable that it be able to handle containers of various shapes, and particularly of various heights, it being understood that to prevent liquid from spilling or splattering, the end walls of the containers 1 and the respective spongy masses 4 rotate while remaining in the immediate vicinity of the gutter 34. For that reason, it is advantageous to have the assembly of the gutter 34 and the ring 46 carrying the spongy masses 4 to be vertically movable. Numerous technical solutions are available to a person skilled in the art. The details of this arrangement, which have no direct connection to the object of the invention, will not be described.

With reference to FIGS. 4A and 4B, we will now describe a currently preferred embodiment of a portion of the support means S for the spongy masses 4.

An arm 60 (which can support, particularly at its lower end, a cam follower cooperating with a fixed cam, neither being visible in FIGS. 3, 4A, and 4B, such that this arm is moved vertically to control the positioning of the spongy mass in contact with the end wall of the container or to move it away therefrom during a cycle) is integral at its upper end with the transfer means formed by said ring 46.

The arm 60 supports a base 61 that is substantially in the form of or at least partially in the form of an approximately horizontal tray 62. The tray 62 is perforated by a multiplicity of holes 63 and forms a grating through which any liquid dripping from the spongy mass can easily flow into the underlying gutter 34.

A platen 64 for receiving at least one spongy mass 4 is removably attached to said base 61 so that the spongy mass is atop said base 61. The platen 64 is at least partially in the form of a substantially horizontal plate 65 and it too is perforated with a multiplicity of holes 66 to facilitate the flow of liquid.

To simplify manufacture of the base 61 and the platen 64, the holes 63 and the holes 66 may not have the same dimensions and/or shapes and/or may not be in line with each other. To allow the liquid to flow easily in spite of this, the plate 65 can be distanced from the platen 64 above the tray 62 of the base 61. For that purpose, the plate 62 is laterally edged with raised edges 67 upon which rest the respective edges of the plate 65, and one or more projecting ribs 67a may optionally also be provided on the plate 62.

For the assembly of the platen 64 to the base 61, the tray may comprise a front vertical skirt 68 oriented upward and equipped with slots 69 suitable for receiving snap-fastening tabs 70 on the front edge of the plate 65. In contrast, means may be provided for quick connection, for example in the form of a trip screw as shown in FIGS. 4A and 4B. For that purpose, the platen 64 may have an upward-turned part 71 equipped with a notch 72 that is suitable for coming into contact with a correspondingly upward-turned part 73 of the base 61; the latter supports a trip screw 74, which, in the position assembling the platen 64 on the base 61, engages in the notch 72 and, after tightening, locks the platen 64 on the base 61. This constitutes an assembly means that is simple to manufacture and easy and quick to maneuver.

Finally, the plate 65 is open in its central part by a recess 75 that opens onto the front edge of said plate, such that the plate 65 has the general appearance of a fork with two arms 75a as visible in FIG. 4B. Under these conditions, the spongy mass 4 is arranged as described above with two lateral scores 17 that slide onto said two respective arms 75a as can be seen in FIG. 4A.

The maintenance process for replacing the spongy masses 4 can be further accelerated by arranging each support means S to support two spongy masses 4 side by side, as illustrated in FIGS. 4A and 4B. Such an arrangement also makes it possible to simplify the support and movement control structure of the spongy masses 4 in an area of the system that is particularly crowded.

Of course, the means that have just been described were provided only as non-limiting examples, and a person skilled in the art is able to identify many alternative embodiments without going beyond the scope of the following claims.

1-20. (canceled)

21. A spongy mass for treating the end walls of containers produced in facilities with very high production rates, said mass being suitable for being held in contact with the end wall of a container for a predetermined period in order to treat said end wall of the container, with said mass:
having a main face for contact with the end wall of the container, and
comprising blind grooves which open onto said main face but do not emerge on the opposite side, and which are distributed into two sets of mutually transverse grooves that delimit blocks,
wherein
said spongy mass is composed of a flexible reticulated foam with semi-open cells and high resilience, and
said spongy mass is composed of polyurethane foam with a mass density between about 10 and 600 kg/m³.

22. The spongy mass according to claim 21, being composed of polyurethane foam with a mass density of about 38 kg/m³.

23. The spongy mass according to claim 21, being composed of polyurethane foam that is either polyether polyurethane foam or polyester polyurethane foam.

24. The spongy mass according to claim 21, wherein said grooves have a depth between about 7 and 15 mm.

25. The spongy mass according to claim 24, wherein said grooves have a depth of about 10 mm.

26. The spongy mass according to claim 24, wherein said grooves have a width of about 1 mm.

27. The spongy mass according to claim 21, wherein said grooves are mutually substantially parallel within each set, and wherein the respective grooves of one set are substantially perpendicular to those of the other set.

28. The spongy mass according to claim 27, wherein said blocks have a substantially square shape measuring about 15 to 25 mm on each side.

29. The spongy mass according to claim 28, wherein said blocks measure about 19 mm on each side and said grooves are spaced about 20 mm apart.

30. The spongy mass according to claim 21, having a substantially quadrangular general shape in a top view, and wherein said grooves of the two sets are substantially parallel to respective sides of said spongy mass.

31. The spongy mass according to claim 30, having a substantially square general shape in a top view.

32. The spongy mass according to claim 21, wherein, in two mutually opposite areas on the periphery of its portion underlying said grooves, said spongy mass comprises two substantially parallel lateral scores cut into the lateral wall of said spongy mass substantially perpendicularly to said grooves.

33. The spongy mass according to claim 21, wherein the main face of the spongy mass is substantially flat.

34. The spongy mass according to claim 21, wherein the main face of the spongy mass is, at least centrally, rounded relative to the shape of the end wall of the containers.

35. A system for treating an end wall of at least one container made of thermoplastic material, comprising:
at least one spongy mass having a predetermined quality, and
support means suitable for maintaining said spongy mass in contact with said end wall of at least one container for a predetermined period,
wherein said spongy mass is according to claim 21.

36. The system according to claim 35, comprising:
conveyor means for conveying the containers, which move in a substantially circular manner and advance the containers along a substantially arc-shaped path between a point of entry and a point of exit,
a plurality of spongy masses supported one after the other,
support means for the respective spongy masses, arranged in a substantially circular manner and made to rotate on a circular path substantially parallel and coaxial to the path traveled by the end walls of the containers,
driving means suitable for mutually moving said conveyor means for the containers and/or said support means for the spongy masses, such that the end walls of the containers are in contact with the respective spongy masses for at least a portion of said arc-shaped path traveled by the containers, and
means of regenerating the predetermined quality of the spongy masses, arranged in the portion of said circular path located between the point of exit and the point of entry of the containers on said path.

37. The system according to claim 36, wherein each support means comprises a substantially flat base perforated with holes, integral with the transfer means, and a platen for receiving at least one spongy mass, said platen, being removably attached to said base.

38. The system according to claim 37, wherein the spongy mass is arranged according to claim 13 and wherein said platen is at least partially in the form of a fork with two arms that are respectively inserted into the two lateral scores in the spongy mass.

39. The system according to claim 37, wherein each support means is arranged to support two spongy masses side by side.

40. Use of a spongy mass according to claim 21, for treating the end walls of containers produced in very high production rate facilities.
